(19) United States
(12) Patent Application Publication
(10) Pub. No.: US 2005/0076566 A1
(43) Pub. Date: Apr. 14, 2005

(54) Method of covering a pot with a floral sleeve having a skirt insert or skirt extension

(76) Inventors: Donald E. Weder, Highland, IL (US); Joseph G. Straeter, Bradenton, FL (US); Michael R. Klemme, Maryville, IL (US)

Correspondence Address: DUNLAP, CODDING & ROGERS P.C., PO BOX 16370, OKLAHOMA CITY, OK, 73113, US

(21) Appl. No.: 10/984,562

(22) Filed: Nov. 9, 2004

Related U.S. Application Data
(63) Continuation of application No. 10/636,521, filed on Aug. 6, 2003, now abandoned.
Application No. 10/636,521 is a continuation-in-part of application No. 10/135,334, filed on Apr. 25, 2002, now abandoned.
Application No. 10/135,334 is a continuation-in-part of application No. 09/972,499, filed on Oct. 5, 2001, now abandoned.
(63) Continuation-in-part of application No. 10/423,497, filed on Apr. 24, 2003.
Application No. 10/423,497 is a continuation-in-part of application No. 09/954,665, filed on Sep. 18, 2001, now abandoned.
Application No. 09/954,665 is a continuation-in-part of application No. 09/612,122, filed on Jul. 7, 2000, now Pat. No. 6,385,904.
Application No. 09/612,122 is a continuation of application No. 09/466,705, filed on Dec. 17, 1999, now Pat. No. 6,105,311.
Application No. 09/466,705 is a continuation of application No. 09/062,329, filed on Apr. 17, 1998, now Pat. No. 6,061,959.
Application No. 09/062,329 is a continuation of application No. 08/749,626, filed on Nov. 18, 1996, now Pat. No. 5,829,194.
Application No. 08/749,626 is a continuation-in-part of application No. 08/458,327, filed on Jun. 2, 1995, now Pat. No. 5,575,133.
Application No. 08/458,327 is a continuation of application No. 08/386,859, filed on Feb. 10, 1995, now Pat. No. 5,493,809.
Application No. 08/386,859 is a continuation-in-part of application No. 08/237,078, filed on May 3, 1994, now Pat. No. 5,625,979.
Application No. 08/237,078 is a continuation-in-part of application No. 08/220,852, filed on Mar. 31, 1994, now Pat. No. 5,572,851.

(51) Int. Cl. A01G 9/02

(52) U.S. Cl. 47/72

(57) ABSTRACT

A floral sleeve and method of using the floral sleeve to cover a floral grouping and/or potted plant are disclosed herein. The floral sleeve has a skirt insert or skirt extension attached to first and/or second panels of the sleeve.

### CROSS REFERENCE TO RELATED APPLICATIONS

The present application is a continuation of U.S. Ser. No. 10/636,521, filed Aug. 6, 2003; which is a continuation-in-part of U.S. Ser. No. 10/135,334, filed Apr. 25, 2002, now abandoned, which is a continuation-in-part of U.S. Ser. No. 09/972,499, filed Oct. 5, 2001, now abandoned. The present application is also a continuation-in-art of U.S. Ser. No. 10/423,497, filed Apr. 24, 2003, which is a continuation-in-part of U.S. Ser. No. 09/954,665, filed Sep. 18, 2001, which is a continuation-in-part of U.S. Ser. No. 09/612,122, filed Jul. 7, 2000, now U.S. Pat. No. 6,389,904, which is a continuation of U.S. Ser. No. 09/466,705, filed on Dec. 17, 1999, now U.S. Pat. No. 6,105,311, which is a continuation of U.S. Ser. No. 09/062,329, filed Apr. 17, 1998, now U.S. Pat. No. 6,061,959, which is a continuation of U.S. Ser. No. 08/749,626, filed Nov. 18, 1996, now U.S. Pat. No. 5,829,194, which is a continuation-in-part of U.S. Ser. No. 08/458,327, filed Jun. 2, 1995, now U.S. Pat. No. 5,575,133, which is a continuation of U.S. Ser. No. 08/386,859, filed Feb. 10, 1995, now U.S. Pat. No. 5,493,809, which is a continuation-in-part of U.S. Ser. No. 08/237,078, filed May 3, 1994, now U.S. Pat. No. 5,625,979, which is a continuation-in-part of U.S. Ser. No. 08/220,852, filed Mar. 31, 1994, now U.S. Pat. No. 5,572,851. All of the patent applications and patents listed herein are hereby expressly incorporated herein by reference in their entireties.

### BACKGROUND

This invention generally relates to sleeves, and, more particularly, to floral sleeves used to contain floral groupings and/or media, or used to wrap flower pots containing floral groupings and/or media containing floral grouping, and methods of using same.

U.S. Pat. Nos. 5,595,022; 5,615,535; 5,740,657; 5,816,023; 5,687,845; 5,810,169; 5,944,187 and 6,152,301, contain subject matter which may be relevant to the present application. The disclosures of each of the above-mentioned patents is hereby expressly incorporated herein by reference.

### BRIEF DESCRIPTION OF THE DRAWINGS

FIG. 1 is an elevational view of a floral sleeve constructed in accordance with the present invention.

FIG. 2 is a cross-sectional view of the floral sleeve of FIG. 1 taken along line 2-2 thereof.

FIG. 3 is a perspective view of the floral sleeve of FIG. 1.

FIG. 4 is a perspective view of the floral sleeve of FIG. 1 in an opened condition and having a pot and floral grouping disposed therein.

FIG. 5 is a bottom plan view of the opened floral sleeve of FIG. 4.

FIG. 6 is an elevational view of an alternate embodiment of the floral sleeve of the present invention.

FIG. 7 is an elevational view of an alternate embodiment of the floral sleeve of the present invention.

FIG. 8 is an elevational view of an alternate embodiment of the floral sleeve of the present invention.

FIG. 9 is an elevational view of an alternate embodiment of the floral sleeve of the present invention.

FIG. 10 is an elevational view of an alternate embodiment of the floral sleeve of the present invention.

FIG. 11 is a perspective view of the floral sleeve of FIG. 10 having a pot and floral grouping disposed therein.

FIG. 12 is an elevational view of an alternate embodiment of the floral sleeve of the present invention.

FIG. 13 is an elevational view of an alternate embodiment of the floral sleeve of the present invention.

FIG. 14 is an elevational view of an alternate embodiment of the floral sleeve of the present invention.

FIG. 15 is an elevational view of another embodiment of the floral sleeve of the present invention.

FIG. 16 is an elevational view of another embodiment of the floral sleeve of the present invention.

FIG. 17 is an elevational view of another embodiment of the floral sleeve of the present invention.

FIG. 18 is a cross-sectional view of the floral sleeve of FIG. 17 taken along line 18-18 thereof.

FIG. 19 is an elevational view of another embodiment of the floral sleeve of the present invention.

FIG. 20 is a perspective view of a sleeve of the present invention which is secured about a pot via a securing element.

FIG. 21 is a perspective view of a sleeve of the present invention which is secured about a pot via a securing element.

### DETAILED DESCRIPTION OF THE INVENTION

The present invention contemplates in a preferred version a preformed flexible floral sleeve having a tubular shape for covering a flower pot having an upper end, a lower end, and an outer peripheral surface. The preformed flexible floral sleeve comprises a body which may have a skirt portion and which may have a straight or non-linear upper edge. The preformed flexible floral sleeve may further comprise a detachable upper portion which may be sized to surround and encompass a floral grouping. The upper portion when present may be detachable via a detaching element, such as but not by way of limitation, perforations, tear strips, weakened areas, or zippers. The upper portion may have one or more apertures for serving as a handle or for enabling the preformed flexible floral sleeve to be supported from a support device.

The preformed flexible floral sleeve (also referred to herein as a floral sleeve, a sleeve or a sleeve cover) may form part of a plant package when used in conjunction with a flower pot disposed within an interior space of the body of the floral sleeve, the flower pot preferably having a floral grouping disposed therein, and wherein the flower pot is substantially surrounded and encompassed by the body and the floral grouping is at least partially surrounded and encompassed and may be entirely enclosed by the upper portion when it forms a part of the floral sleeve.

Also, the body may comprise an adhesive or cohesive bonding material disposed on an inner surface thereof for bondingly connecting the body to a flower pot disposed therein. Alternately, a bonding material may be disposed on an outer surface of the body for securing a crimped portion having a plurality of crimped folds formed in the body.

These embodiments and others of the present invention are now described in more detail below. It will be appreciated that the examples provided herein are not intended to limit the scope and extent of the claimed invention but are only intended to exemplify various embodiments of the invention contemplated herein.

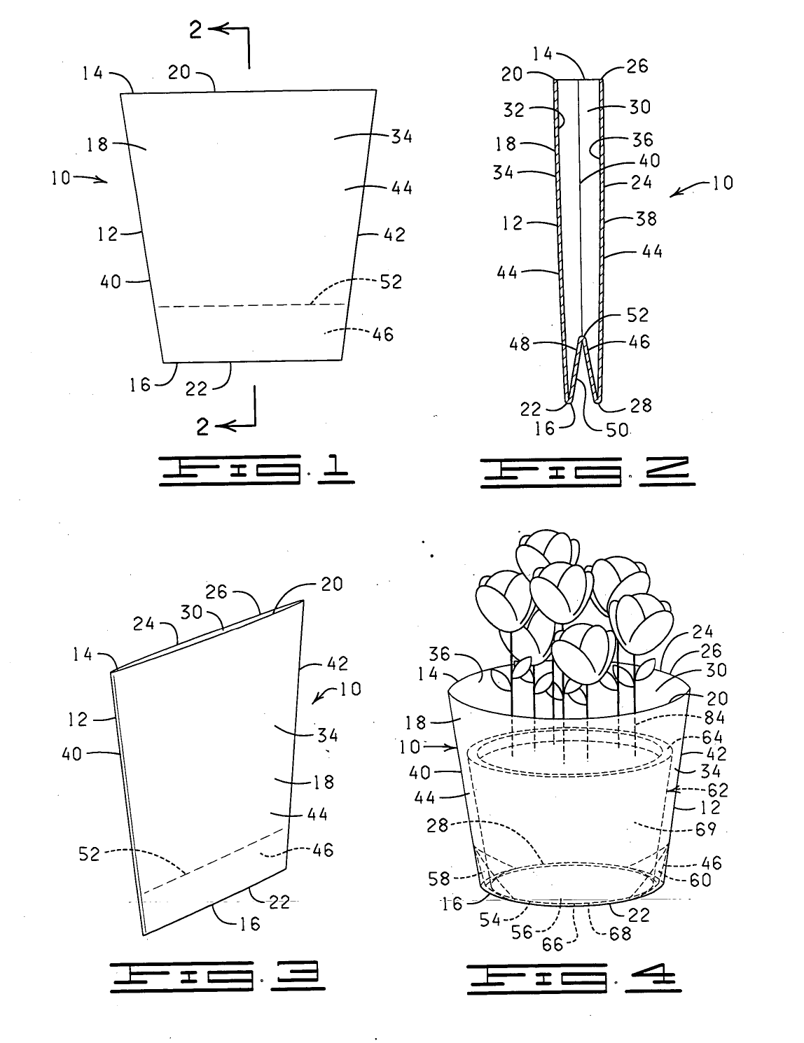

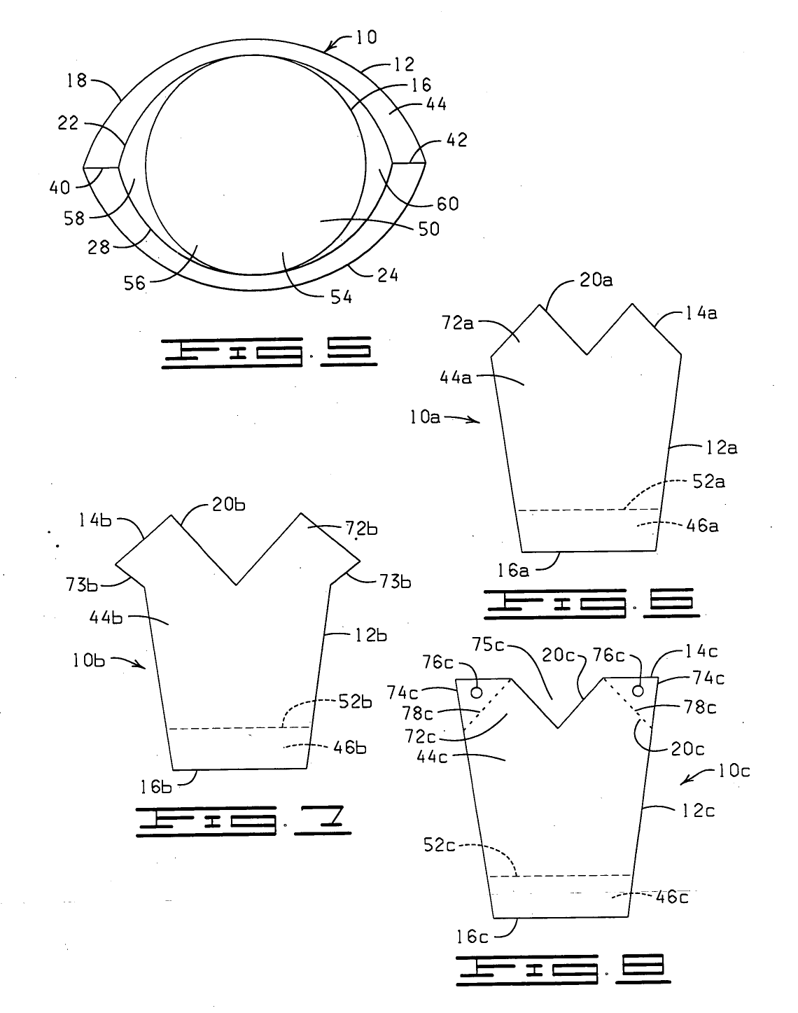

Referring now to the drawings, shown in FIGS. 1-5 and designated therein by the general reference numeral 10 is a floral sleeve, also referred to herein simply as a sleeve. The floral sleeve 10 is initially in a substantially flattened state (FIGS. 1-3) and is openable to an opened condition (FIGS. 4-5) for containing and covering a flower pot. The floral sleeve 10 has a body 12 having an upper end 14, a lower end 16, a first panel 18 having a first upper edge 20 and a first lower edge 22 and a second panel 24 having a second upper edge 26 and a second lower edge 28 which is generally parallel and adjacent to the first lower edge 22. The body 12 has an interior space 30. The first panel 18 has an inner surface 32 and an outer surface 34. The second panel 24 has an inner surface 36 and an outer surface 38.

In the flattened condition, the first panel 18 and second panel 24 are positioned flatwise upon each other and are connected along a sealed left side edge 40 and a sealed right side edge 42 both of which extend from the upper end 14 to the lower end 16. The first panel 18 and second panel 24 together comprise a sidewall 44 of the body 12. The body 12 further comprises a gusset 46 extending inwardly into the interior space 30 from the first lower edge 22 and the second lower edge 28. The gusset 46 has an inner surface 48 exposed to the interior space 30 and an outer surface 50 exposed outwardly. The gusset 46 has an inner fold 52 which extends from the left side edge 40 to the right side edge 42. The body 12 preferably has a tapered shape in the flattened condition, wherein the body 12 is wider at the upper end 14 and more narrow at the lower end 16, such that in the opened condition the floral sleeve 10 preferably has a frusto-conical shape (FIG. 4). As noted, the floral sleeve 10 preferably has a frusto-conical shape when opened, but may be cylindrical or may even have a rectangular shape when opened. This type of gusset has the utilitarian advantage over other gussets used in sleeves in the floral industry in that a decoration placed on the first panel 18 and/or on second panel 24 remains substantially undistorted by folds when the floral sleeve 10 (or other floral sleeves described herein) is used to cover a pot 62, thereby providing a more pleasing decorative appearance to the covered pot 62.

When the floral sleeve 10 is converted to an opened condition, the gusset 46 is unfolded to form a bottom 54 in the body 12. When the pot 62 is disposed within the interior space 30 and a bottom 68 of a lower end 66 of the pot 62 is disposed upon the bottom 54 of the body 12, the bottom 54 has three surface portions, including (1) a lower bottom surface 56 covering the bottom 68 of the pot 62, (2) a left side bottom surface 58 which extends upwardly from the lower bottom surface 56 and is disposed between the sidewall 44 of the body 12 and an outer peripheral surface 69 of the pot, and (3) a right side bottom surface 60 which extends upwardly from the lower bottom surface 56 and is disposed between the sidewall 44 of the body 12 and the outer peripheral surface 69 of the pot. In the opened condition of the floral sleeve 10, the bottom 54 of the body 12 is substantially completely concealed by a lower portion of the sidewall 44 of the body 12.

Referring now to FIG. 6, another floral sleeve embodied in the present invention is designated therein by reference numeral 10a. Floral sleeve 10a has a body 12a, an upper end 14a, a lower end 16a, a skirt upper edge 20a, a sidewall 44a, a gusset 46a, and an inner gusset fold 52a. The skirt upper edge 20a is unsealed and can be opened for disposition of a pot. The floral sleeve 10a is essentially the same as floral sleeve 10 except the upper edge 20a has a non-linear (angular) pattern forming a skirt portion 72a in the body 12a. Generally, the skirt portion 72a is sized to extend a distance above an upper end 64 of the pot 62 (FIG. 4) when the pot 62 is disposed within the floral sleeve 10a when in the opened condition. Alternatively, the skirt portion 72a may be sized so that when the pot 62 is disposed therein, the upper edge 20a may be positioned partially or entirely below the upper end 64 of the pot 62.

Referring now to FIG. 7 another floral sleeve embodied in the present invention is designated therein by reference numeral 10b. Floral sleeve 10b has a body 12b, an upper end 14b, a lower end 16b, an upper edge 20b, a sidewall 44b, a gusset 46b, and an inner gusset fold 52b. The floral sleeve 10b is essentially the same as floral sleeve 10a except the upper edge 20b has a skirt portion 72b which has an outwardly flared portion 73b extending beyond the body 12b. The skirt portion 72b is preferably sized to extend a distance above the upper end 64 of the pot 62 when the pot 62 is disposed within the floral sleeve 10b when in the opened condition but may alternatively be sized to be below the upper end 64 of the pot 62. The skirt upper edge 20b, and the outwardly flared portion 73b of the skirt portion 72b extending beyond the body 12b are unsealed.

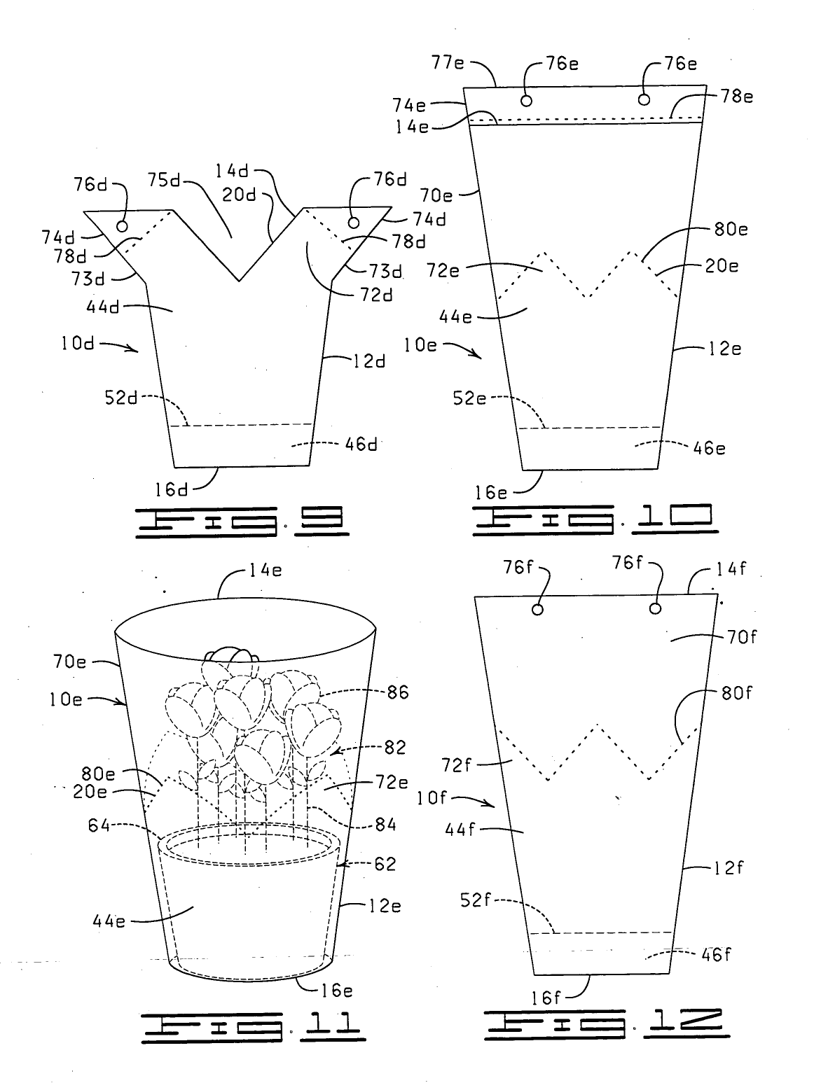

Referring now to FIG. 8, a preferred floral sleeve embodiment of in the present invention is designated therein by reference numeral 10c. Floral sleeve 10c has a body 12c, a skirt portion 72c in the body 12c, an upper end 14c, a lower end 16c, a skirt upper edge 20c, a sidewall 44c, a gusset 46c, and an inner gusset fold 52c. The floral sleeve 10c is essentially similar to floral sleeve 10a except the floral sleeve 10c further comprises a pair of upper support elements 74c preferably each having an aperture 76c and which are each detachable via a detaching element 78c. There is a gap or notch 75c between the upper support elements 74c which increases the ease with which the sleeve 10c can be opened and the pot 62 disposed therein by reducing excess material which could interfere with deposition of the pot 62 into the sleeve 10c. The apertures 76c serve to adapt each upper support element 74c to support the entire floral sleeve 10c from a support assembly such as a wicket, hanger, staple, pin, clip, hook, or rod, for example. For example, a plurality of sleeves 10c may be supported on a portable banding device, such as the banding device shown in U.S. patent application Ser. No. ______ Atty. Dkt.# 8403.456, filed on Apr. 9, 2002, Express Mail No. EV 010195862 US, entitled “METHOD AND APPARATUS FOR SECURING A DECORATIVE COVER ABOUT A FLOWER POT” the specification and drawings of which are expressly incorporated by reference herein in their entirety, which can be used manually or automatically to apply one of such sleeves 10c about a potted plant. As the sleeve 10c is removed, the upper support elements 74c remain behind on the portable banding device. In an alternative embodiment, a plurality of floral sleeves 10c may be provided in a pad, with the upper support element 74c of adjacent floral sleeves 10c connected together by an adhesive or cohesive bonding material, a staple, clip, or pin in a manner well known in the art. Preferably, the body 12c and skirt portion 72c of the floral sleeve 10c are detached from the upper support element 74c before the sleeve 10c is placed about the pot 62.

Referring now to FIG. 9, another floral sleeve embodied in the present invention is designated therein by reference numeral 10d. Floral sleeve 10d has a body 12d, a skirt portion 72d in the body 12d, an upper end 14d, a lower end 16d, a sidewall 44d, a skirt upper edge 20d, a gusset 46d, and an inner gusset fold 52d. The floral sleeve 10d is essentially similar to floral sleeve 10c in that the floral sleeve 10d comprises upper support elements 74d each preferably having at least one aperture 76d and which is detachable via a detaching element 78d. There is a gap or notch 75d between the upper support elements 74d. The apertures 76 serve to adapt each upper support element 74d to support the entire floral sleeve 10d from a support assembly as defined above. The skirt portion 72d has outwardly flared portions 73d which preferably are unsealed, as is the remainder of the upper edge 20d. In an alternative embodiment as described above, a plurality of floral sleeves 10d may be provided in a pad, with the upper support elements 74d of adjacent floral sleeves 10d connected together by an adhesive or cohesive bonding material or other attaching device in a manner well known in the art. Preferably, the body 12d and skirt portion 72d of the floral sleeve 10d are detached from the upper portion 74d before the sleeve 10d is placed about the pot 62.

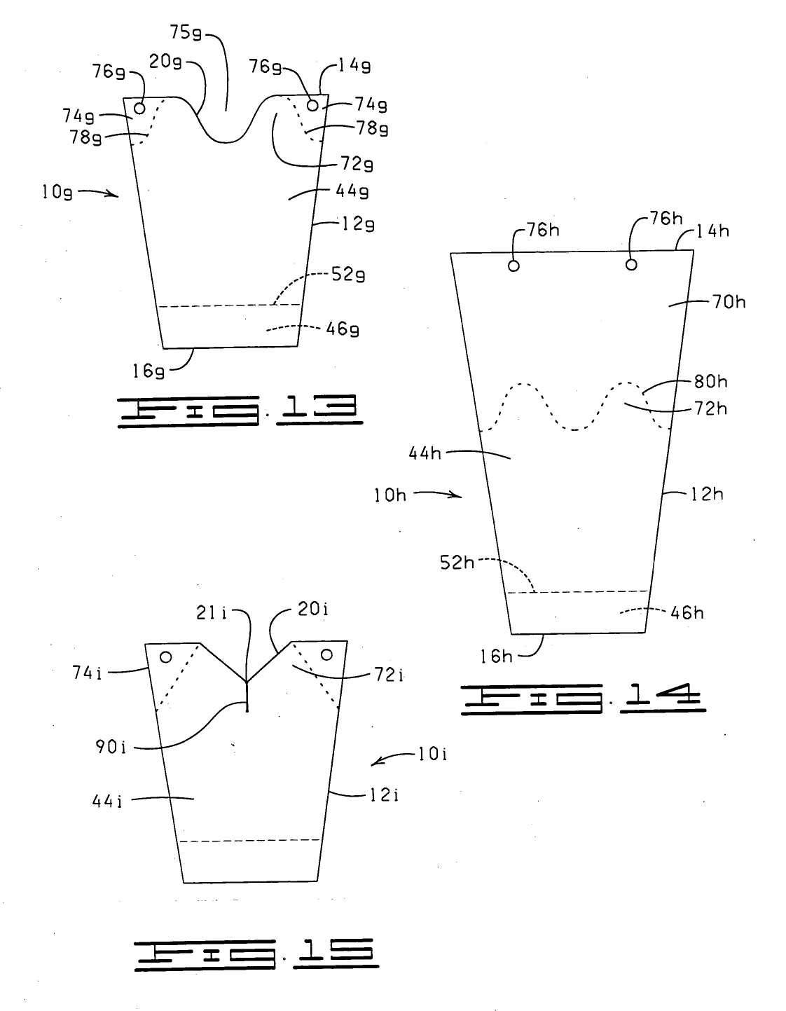

Referring now to FIGS. 10 and 11, another floral sleeve embodied in the present invention is designated therein by reference numeral 10e. Floral sleeve 10e has a body 12e, a skirt portion 72e in the body 12e, an upper end 14e, a lower end 16e, a sidewall 44e in the body 12e, a gusset 46e, and an inner gusset fold 52e. The floral sleeve 10e further comprises an upper portion 70e and a support element 74e having apertures 76e and an upper edge 77e which is detachable from the upper portion 70e via a detaching element 78e. The apertures 76e are optional and serve to adapt the upper portion 70e to support the entire floral sleeve 10e from a support assembly as defined elsewhere herein. In an alternative embodiment, a plurality of floral sleeves 10e may be provided in a pad, with the upper portions 70e of adjacent floral sleeves 10e connected together by an adhesive or cohesive bonding material or other connecting device in a manner well known in the art.

The upper portion 70e is generally sized to surround and enclose a floral grouping 82 having a lower portion 84 and an upper portion 86 comprising blooms and/or foliage, which is disposed within the pot 62 when the pot 62 and floral grouping 82 therein is disposed within the opened floral sleeve 10e. The upper portion 70e can be detached from the body 12e via a detaching element 80e at some time after the floral sleeve 10e has been disposed about the pot 62 and floral grouping 82, for example after the pot 62 and floral grouping 82 therein have been shipped to a vendor, but may be detached at any time, either before or after the pot 62 and floral grouping 82 have been placed within the floral sleeve 10e. When the upper portion 70e is detached, the skirt portion 72e remains with the body 12e leaving a covering such as sleeve 10a disposed about the pot 62. The detaching element 80e leaves a skirt upper edge 20e on the skirt portion 72e in the body 12e. The skirt portion 72e preferably is sized to extend above the upper end 64 of the pot 62 when disposed within the floral sleeve 10d although the skirt upper edge 20d may be below the upper end 64 of the pot 62.

Referring now to FIG. 12, another floral sleeve embodied in the present invention is designated therein by reference numeral 10f. Floral sleeve 10f has a body 12f, a skirt portion 72f, an upper end 14f, a lower end 16f, a sidewall 44f, a gusset 46f, and an inner gusset fold 52f. The floral sleeve 10f is similar to floral sleeve 10e in that the floral sleeve 10f comprises an upper portion 70f having apertures 76f and which is detachable from the skirt portion 72f via a detaching element 80f. The apertures 76f are optional and serve to adapt the upper portion 70f to support the entire floral sleeve 10f from a support assembly such as described elsewhere herein. Sleeve 10f differs from sleeve 10e primarily in that sleeve 10f does not have a separate support element which is detachable from upper portion 70f. The detaching element 80f has an angular pattern such that when the upper portion 70f is detached from the body 12f, the skirt portion 72f is left on the body 12f. The skirt portion 72f preferably is sized to extend above the upper end 64 of the pot 62 when disposed within the floral sleeve 10f.

Referring now to FIG. 13, another floral sleeve embodied in the present invention is designated therein by reference numeral 10g. Floral sleeve 10g has a body 12g having a skirt portion 72g, an upper end 14g, a lower end 16g, a skirt upper edge 20g, a sidewall 44g, a gusset 46g, and an inner gusset fold 52g. The floral sleeve 10g is similar to floral sleeve 10c in that the floral sleeve 10g comprises upper support elements 74g and preferably having apertures 76g and which are detachable via detaching elements 78g. There is a gap or notch 75g between upper support elements 74g. The apertures 76g are optional and serve to adapt the upper support elements 74g to support the entire floral sleeve 10g from a support assembly as described elsewhere herein. In an alternative embodiment, a plurality of floral sleeves 10g may be provided in a pad, as described elsewhere herein.

The detaching element 78g and skirt upper edge 20g differ from detaching element 78c and upper skirt edge 20c of floral sleeve 10c in that detaching element 78g and upper skirt edge 20g have a curved non-linear pattern rather than an angular non-linear pattern, such that when the upper support elements 74g are detached from the body 12g, the skirt portion 72g is left with the curved upper edge 20g. The skirt portion 72g preferably is sized to extend above the upper end 64 of the pot 62 when disposed within the floral sleeve 10g but may be sized to be below the upper end 64 of the pot 62 in an alternate embodiment.

Referring now to FIG. 14, another floral sleeve embodied in the present invention is designated therein by reference numeral 10h. Floral sleeve 10h has a body 12h, an upper end 14h, a lower end 16h, a sidewall 44h, a gusset 46h, and an inner gusset fold 52h. The floral sleeve 10h is essentially similar to floral sleeve 10f in that the floral sleeve 10h comprises an upper portion 70h having apertures 76h and which is detachable from a skirt portion 72h via a detaching element 80h. The apertures 76h are optional and serve to adapt the upper portion 70h to support the entire floral sleeve 10h from a support assembly such as described elsewhere herein.

The upper portion 70h preferably is sized to surround and enclose the floral grouping 82 as described for sleeve 10f. The upper portion 70h is generally detached from the body 12h via the detaching element 80h preferably at some time after the floral sleeve 10h has been disposed about the pot 62 and floral grouping 82, but may be detached at any time, either before or after the pot 62 and floral grouping 82 are placed within the floral sleeve 10h.

The detaching element 80h differs from detaching element 80f of floral sleeve 10f in that detaching element 80h has an curved pattern rather than an angular pattern, such that when the upper portion 70h is detached from the body 12h, the skirt portion 72h is left extending from the body 12h, in a manner similar to other sleeves described herein.

The upper edges 20a-20d and 20g of sleeves 10a-10d and 10g, respectively, and the detaching elements 80e-80f and 80h of sleeves 10e, 10f and 10h, respectively, are shown as having angular non-linear patterns or curved non-linear patterns. The angular and curved patterns are but two non-linear patterns which may be employed in the construction of the floral sleeves contemplated herein. Other configurations will be readily apparent to those of ordinary skill in the art, for example, those shown in, but not limited to, FIGS. 2A-2F of U.S. Pat. No. 5,829,225, the specification of which is hereby expressly incorporated herein by reference in its entirety.

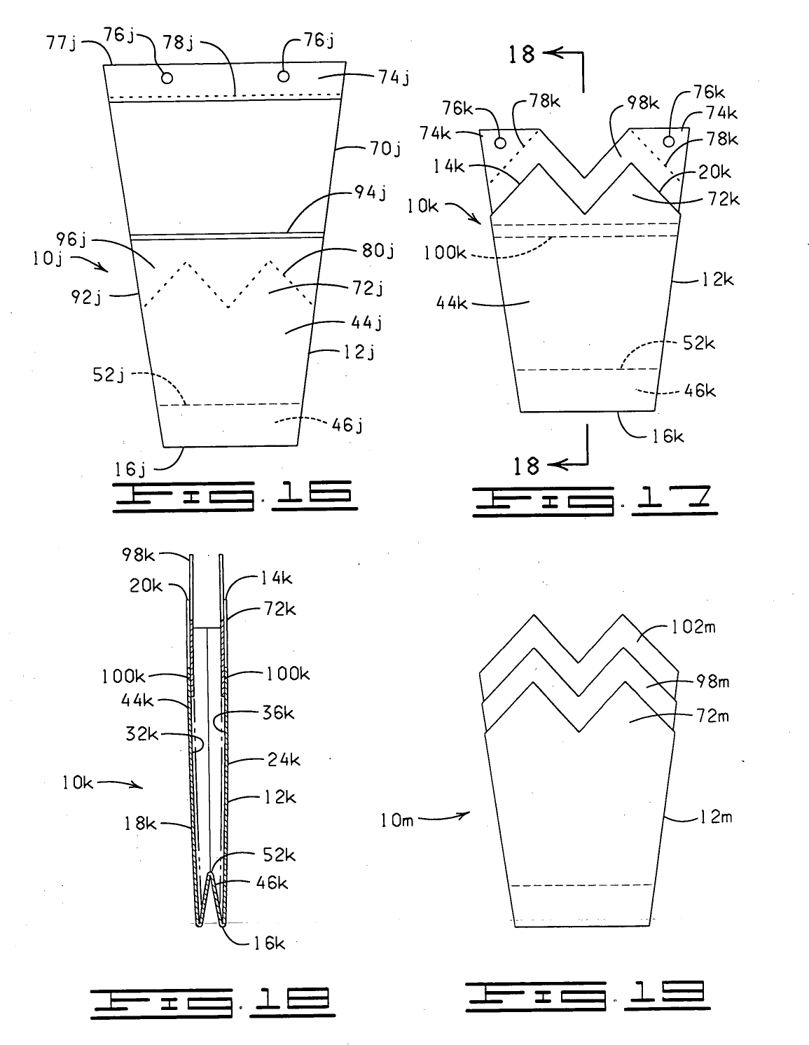

Referring now to FIG. 15, another floral sleeve embodied in the present invention is designated therein by reference numeral 10i which is similar to sleeve 10c, comprising a body 12i having a sidewall 44i, a skirt portion 72i in the body 12i, the skirt portion 72i having a skirt upper edge 20i and support elements 74i. Sleeve 10i further comprises a slit 90i (which may also comprise perforations or may be entirely severed) which extends from a center point 21i in skirt upper edge 20i and extends a distance downwardly into body 12i for enabling the skirt portion 72i to extend further outwardly when the pot 62 is disposed therein. Any of the sleeves described herein may comprise a slit such as slit 90i positioned therein.

Referring now to FIG. 16, another floral sleeve embodiment of the present invention is designated therein by reference numeral 10j. Floral sleeve 10j has a lower portion 92j and an upper portion 70j. The lower portion 92j has a body 12j and a lower end 16j, a sidewall 44j in the body 12j, a skirt portion 72j in the body 12j, and a detaching element 80j in the lower portion 92j. The upper portion 70j is attached to the lower portion 92j along a horizontal seal 94j extending across sleeve 10j. Between the horizontal seal 94j and the detaching element 80j is a medial portion 96j which is removed along with the upper portion 70j when the upper portion 70j is detached.

The upper portion 70j and the lower portion 92j are constructed of separate webs of material connected along the horizontal seal 94j. Preferably, the lower portion 92j is constructed of a decorative material and the upper portion 70j is constructed of a clear or transparent material. Sleeve 10j is similar to sleeve 10e in that in sleeve 10j, the upper portion 70j further comprises a support element 74j preferably having apertures 76j, an upper edge 77j and is detachable via a detaching element 78j in a manner similar to sleeve 10e. In an alternative embodiment, the sleeve 10j may be constructed without a support element 74j in a manner similar to sleeve 10f. Lower portion 92j further comprises in the body 12j a gusset 46j and an inner gusset fold 52j. The apertures 76j serve to support the sleeve 10j in a manner as described elsewhere herein before, and a plurality of sleeves 10j may be connected into a pad as described elsewhere herein before. Sleeve 10j is further similar to sleeves 10e and 10f in that the upper portion 70j is preferably sized to surround and enclose the floral grouping 82 when disposed within the opened floral sleeve 10j, as described elsewhere herein.

When the upper portion 70j and the medial portion 96j are removed, the skirt portion 72j and body 12j provide a covering such as sleeve 10a disposed about the pot 62. In an alternative version, no skirt portion is left in the body when an upper portion is removed, and may provide a covering similar to sleeve 10, or may provide a covering having an upper edge which is positioned below the upper end 64 of the pot 62 when the pot 62 is disposed therein.

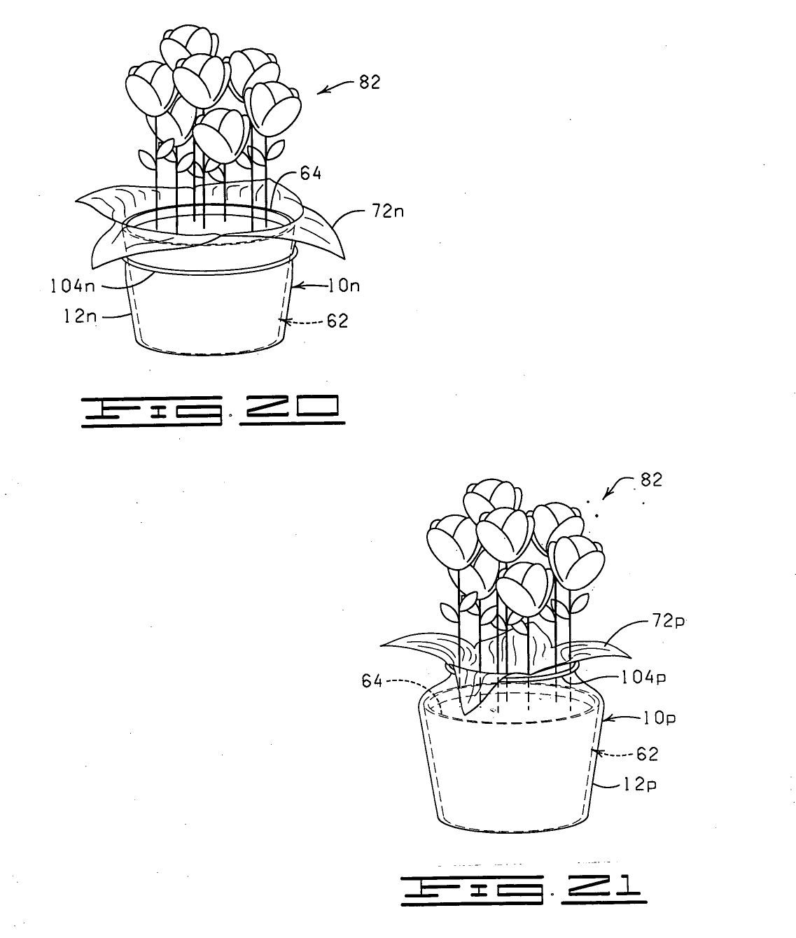

Referring now to FIGS. 17 and 18, another floral sleeve embodied in the present invention is designated therein by reference numeral 10k. Floral sleeve 10k is similar to sleeve 10a for example, in that it comprises a body 12k, and upper end 14k, a lower end 16k, a sidewall 44k, a gusset 46k with an inner fold 52k, and a skirt portion 72k in the body 12k. The sleeve 10k further comprises a skirt insert 98k which extends beyond an upper edge 20k of the skirt portion 72k. The sleeve 10k comprises a pair of support elements 74k which extend from the skirt insert 98k and which are detachable thereon via detaching, elements 78K. Support elements 74k preferably comprise apertures 76k for supporting the sleeve 10k from a support assembly. The skirt insert 98k is preferably attached or laminated via a skirt seal 100k to portions of an inner surface 32k of a first panel 18k and inner surface 36k of a second panel 24k of the sleeve 10k (FIG. 18). Preferably, the skirt insert 98k is constructed of a material which is different from the remainder of the material used to construct the body 12k and skirt portion 72k, or is a material which has a different color or pattern but which is otherwise similar to the material used to construct the body 12k and the skirt portion 72k.

For example, the body 12k, skirt 72k, and skirt insert 98k may be constructed of metallized film, polymer film, foil, spun bonded or melt blown material, lace material, fabric, or cellophane, any of which may have different colors, patterns or textures. For example, the body 12k and skirt portion 72k may be constructed of a metallized polymer film while the skirt insert 98k is constructed of a fabric, lace material, or spun bonded material. Other combinations will readily come to the mind of the person of ordinary skill in the art.

Further, the skirt insert 98k may be attached to only one of the first panel 18k or the second panel 24k of the sleeve 10k rather than to both the first panel 18k and second panel 24k as shown in FIG. 18. Further, any of the sleeves described herein may be constructed to have a skirt insert such as skirt insert 98k. For example, sleeve 10 may be constructed to have a skirt insert such as skirt insert 98k which is attached near the upper end 14 of the body 12 of sleeve 10. Further, any of the sleeves described herein may have more than one skirt insert such as a shown in FIG. 19 wherein a floral sleeve 10m comprises a body 12m, a skirt portion 72m, a first skirt insert 98m and a second skirt insert 102m. Any of the sleeves described herein may have two or more skirt insets as shown for sleeve 10m, and, each of the skirt inserts may each be constructed of different materials or materials having different colors or patterns.

It will also be understood by a person of ordinary skill in the art that although the location of the skirt seal 100k of the skirt insert 98k is shown as being positioned near the upper end 14k, the skirt seal 100k may in fact be positioned at any location below the upper end 14k at any position on the inner surface 32k and inner surface 36k of the sleeve 10k (as shown in phantom in FIG. 18). Further, the skirt insert 98k may be attached after the body 12k and skirt portion 72k of sleeve 10k have been formed, or before the material has been formed into the body 12k and skirt portion 72k by the sleeve forming apparatus. In other words, the separate materials used to construct the body 12k and the skirt insert 98k may be laminated together while the webs of material are in a flattened, unformed condition. Where used herein, the term “skirt insert” may also be used interchangeably with the term “skirt extension” in that the “skirt insert” may not actually have been “inserted” into the sleeve but may have been “pre-attached” by lamination as described above.

As noted above, the sleeves described herein can be constructed, in whole or in part, from materials including, but not limited to, polymer films, metallized polymer films, natural films, metallized natural films, printed materials of any type, matted materials of any type, cloth, fabric, spun bonded or melt blown materials, paper, tissue, cellophane, biodegradable materials, recyclable materials, and metal foils.

As noted above, any of the sleeves described herein may comprise a skirt insert. In those sleeve embodiments having both a skirt insert and an upper portion sized to surround and enclose a floral grouping, and/or for supporting the sleeve from a support assembly or as an attachment within a pad, the upper portion may be attached to the body, to the skirt portion, or to the skirt insert of the sleeve.

Any of the sleeves described herein may be banded about a potted plant as shown in FIGS. 20 and 21. FIG. 20 shows a sleeve 10n having a body 12n and a skirt portion 72n positioned about the pot 62 and floral grouping 82, the sleeve 10n secured about the pot 62 via a securing element 104n, wherein the securing element 104n is positioned below the upper end 64 of the pot 62. FIG. 21 shows a sleeve 10p having a body 12p and a skirt portion 72p positioned about the pot 62 and floral grouping 82 and secured thereto via a securing element 104p, wherein the securing element 104p is positioned above the upper end 64 of the pot 62. More than one securing element 104n or 104p can be used. The securing elements 104n and 104p preferably are banding elements such as, elastic bands, plastic bands, strings, ribbons, ties, tapes, labels, wires, collars, stribbons, rubber bands, but may also be adhesive or cohesive materials, barbs on the pot 62, pins, clips, springs, staples, magnets, or any other binding or securing materials known in the art.

Any of the sleeves described herein in any embodiments can be used to contain floral groupings or plants with or without pots, and with or without a growing medium or support medium such as a floral foam. When used with a growing medium, they may be used to cultivate a botanical item. The sleeves described herein may be used as flexible vases to contain floral groupings and preferably are waterproof or leak resistant. The sleeves described herein may be used as covers for jardinieres, for pots or for vases, or any type of floral grouping or floral container. Any of the sleeves described herein may be equipped with reservoirs, pouches or packets for containing moisture, fertilizers, growing media, or other items useful or beneficial for growth or presentation of floral grouping or other botanical items. The reservoirs, pouches or packets may be attached to an inner portion of the sleeve.

Any of the sleeves described herein can be constructed using multiple webs of material which are laminated or attached together to achieve contrasting effects in the completed sleeve, produced for example by using webs of materials having different patterns, colors, or textures.

For example, a 20″×20″ sheet of metallized film may be used in conjunction with a 24″×24″ sheet of spun bonded material; or, a 20″×20″ sheet of metallized material may be used with a 24″×24″ sheet of lace material and with a 28″×28″ sheet of spun bonded material.

Further, by laminating a narrower web and a wider web, centering the narrower web on the wider web. Any number of consecutive webs can be used in the process. These webs need not be laminated but could be left un-laminated and held in place only by the seal on the sleeve. However, for ease of processing, it may be preferable in some instances and with some equipment to laminate either by overall adhesively laminating or spot laminating or strip laminating the material. It may be preferable to leave certain portions of the material un-laminated so as to provide the appearance of separate sheets.

Using the lamination technique or using a sleeve made without lamination but using multiple materials, it is not necessary to use an entire standard web. For example, it is possible to take a 20″ web as the base web and to laminate two additional webs of 3″ each, for example, overlapping 1″ of each of the two additional 3″ strips over the base web and laminating them at that point or simply feeding them into the machine at that point and forming them. Or, entirely overlapping webs could be used, that is, one 20″ web is centered on a 24″ web. It could be laminated or un-laminated as it passes through the sleeve forming machine.

Any of the flexible floral sleeves contemplated herein may also be equipped with drainage elements (e.g., one or more holes) in the bodies 10-10h thereof or ventilation holes (not shown) in the bodies 10-10p or upper portions 70e, 74f or 74h, for example, or can be made from permeable or impermeable materials.

The materials from which the flexible floral sleeves 10-10p are constructed preferably have a thickness in a range from about 0.1 mil to about 30 mils. Often, the thicknesses of the floral sleeves 10-10p are in a range from about 0.5 mil to about 10 mils or preferably, in a range from about 1.0 mil to about 5 mils. Preferably, the floral sleeves 10-10p are constructed from a material which is flexible, semi-rigid, rigid, or any combination thereof. The floral sleeves 10-10p may be constructed of a single layer of material or a plurality of layers of the same or different types of materials. Any thickness of the material may be utilized as long as the material functions in accordance with the present invention as described herein. The layers of material comprising the flexible floral sleeves may be connected together or laminated or may be separate layers. Such materials used to construct the floral sleeves are described in U.S. Pat. No. 5,111,637, which is hereby expressly incorporated herein by reference. Any thickness of material may be utilized in accordance with the present invention as long as the floral sleeves 10-10p may be formed as described herein, and as long as the floral sleeves 10-10p may contain at least a portion of a flower pot, potted plant, growing medium or floral grouping, as described herein. Additionally, an insulating material such as bubble film, preferable as one of two or more layers, can be utilized in order to provide additional protection for the item, such as the floral grouping, contained therein.

As noted above, the floral sleeves 10-10p are constructed from any suitable material that is capable of being formed into a floral sleeve as contemplated herein and wrapped about a flower pot and a floral grouping disposed therein. Preferably, the material comprises treated or untreated paper, metal foil, polymeric film, non-polymeric film woven, or nonwoven fabric, or synthetic or natural fabric, cardboard, fiber, cloth, burlap, or laminations or combinations thereof.

The term “polymeric film” when used herein means a film made of a synthetic polymer such as a polypropylene or a naturally occurring polymer such as cellophane. A polymeric film is relatively strong and not as subject to tearing (substantially non-tearable), as might be the case with paper or foil.

In one embodiment, the floral sleeves 10-10p may be constructed from sheets comprising two polypropylene films. The material comprising the flexible floral sleeves 10-10p may be connected together or laminated or may be separate layers. In an alternative embodiment, the flexible floral sleeves 10-10p may be constructed from only one sheet of the polypropylene film.

The materials comprising the floral sleeves 10-10p may vary in color and as described herein consists of designs or decorative patterns which are printed, etched, and/or embossed thereon using inks or other printing materials. An example of an ink which may be applied to the surface of the material is described in U.S. Pat. No. 5,147,706, which is hereby expressly incorporated herein by reference.

In addition, the material may have various colorings, coatings, flocking and/or metallic finishes, or other decorative surface ornamentation applied separately or simultaneously or may be characterized totally or partially by pearlescent, translucent, transparent, iridescent, neon, or the like, qualities. The material may further comprise, or have applied thereto, one or more scents. Each of the above-named characteristics may occur alone or in combination and may be applied to the upper and/or lower surface of the material comprising the floral sleeves 10-10p. Moreover, portions of the material used in constructing the floral sleeves 10-10p may vary in the combination of such characteristics. The material utilized for the floral sleeves 10-10p may be opaque, translucent, transparent, or partially clear or tinted transparent.

The term “floral grouping” as used herein means cut fresh flowers, artificial flowers, a single flower or other fresh and/or artificial plants or other floral materials and may include other secondary plants and/or ornamentation or artificial or natural materials which add to the aesthetics of the overall floral grouping. The floral grouping comprises a bloom or foliage portion and a stem portion. Further, the floral grouping may comprise a growing potted plant having a root portion (not shown) as well. However, it will be appreciated that the floral grouping may consist of only a single bloom or only foliage, or a botanical item (not shown), or a propagule (not shown). The term “floral grouping” may be used interchangeably herein with both the terms “floral arrangement” and “potted plant”. The term “floral grouping” may also be used interchangeably herein with the terms “botanical item” and/or “propagule”.

The term “growing medium” when used herein means any liquid, solid or gaseous material used for plant growth or for the cultivation of propagules, including organic and inorganic materials such as soil, humus, perlite, vermiculite, sand, water, foam, and including the nutrients, fertilizers or hormones or combinations thereof required by the plants or propagules for growth.

The term “botanical item” when used herein means a natural or artificial herbaceous or woody plant, taken singly or in combination. The term “botanical item” also means any portion or portions of natural or artificial herbaceous or woody plants including stems, leaves, flowers, blossoms, buds, blooms, cones, or roots, taken singly or in combination, or in groupings of such portions such as bouquet of floral grouping. The term “propagule” when used herein means any structure capable of being propagated or acting as an agent of reproduction including seeds, shoots, stems, runners, tubers, plants, leaves, roots, or spores.

In accordance with the present invention a bonding material may optionally be disposed on a portion of any of the floral sleeves 10-10p described herein to attach each floral sleeve 10-10p to a flower pot 62 having a floral grouping 82 therein when such a flower pot 62 is disposed within the floral sleeve 10-10p or to assist in closing or sealing the upper portion 70e, 70f or 70h of the floral sleeve 10e, 10f or 10h or in adhering the floral sleeve 10-10p to the flower pot 62 after the flower pot 62 has been disposed therein. Examples of how a bonding material may be disposed on the floral sleeve 10-10p are shown in U.S. Pat. No. 5,493,809 and in 5,625,979, each of which is hereby expressly incorporated herein by reference in its entirety.

The term “detaching element” 78c, 78d, 78e, 78g, 80e, 80f or 80h, for example, when used generally herein, means any element or device such as, but not limited to, perforations, tear strips, zippers, and any other devices or elements of this nature known in the art, or any combination thereof, which enable the tearing away or detachment of one object from another. Therefore, while perforations are shown and described in detail herein, it will be understood that tear strips, zippers, or any other “detaching element” known in the art, or any combination thereof, could be substituted therefore and/or used therewith.

The upper portions 70e, 70f, 70h and 70j of the floral sleeves 10e, 10f, 10h and 10j, respectively may also have an additional vertical detaching element comprising a plurality of vertical perforations (not shown) for facilitating removal of the upper portion 70e, 70f, 70h and 70j and which are disposed more or less vertically therein.

It will be understood by a person of ordinary skill in the art that equipment and devices for forming flexible floral sleeves are commercially available, and are well known to a person of ordinary skill in the art. Therefore, further detailed discussion of the construction of the sleeves described herein is not deemed necessary.

However, briefly, the flexible floral sleeves 10-10p described herein may be formed by intermittently advancing, one or two webs preformed in the form of a tube, or a single web folded double, indenting the lower end to form a folded pouch portion for forming the gusset, and sealing the longitudinal sides of the two facing panels and the sides of the gussets, then cutting the floral sleeve 10-10p thus formed from the webs or web. Machines which can form floral sleeves 10-10p from such single webs or tubes are well within the knowledge of one of ordinary skill in the art.

The term “flower pot” or “pot” 62 as used herein refers to any type of container used for holding a floral grouping or plant, including vases. Examples of pots, used in accordance with the present invention include, but are not limited to, clay pots, foam pots, wooden pots, plastic pots, pots made from natural and/or synthetic fibers, and/or any combination thereof. The flower pot 62 is adapted to receive a floral grouping 82 in the retaining space thereof. The floral grouping 82 may be disposed within the flower pot 62 along with a suitable growing medium described elsewhere herein, or other retaining medium, such as a floral foam. It will also be understood that a floral grouping, botanical item or propagule and any appropriate growing medium or other retaining medium, may be disposed in the floral sleeve 10-10p without the flower pot 62 for displaying, transporting or cultivating the item disposed within the floral sleeve 10-10p.

Preferably the floral sleeve 10-10p is sized to contain and conform to one of a variety of standard sizes of pots known to those of ordinary skill in the art, such as 3½ inch, 4 inch, 4½ inch, 5 inch, 5½ inch, 6 inch, 6½ inch, 7 inch, 7½ inch, 8 inch and 8½ inch pots or pots that are larger than, smaller than, or intermediate between such pot sizes.

Although not shown herein, any of the sleeves 10-10p described herein may be used as a container for a growing medium and a floral grouping 82 wherein the floral grouping 82 is disposed within the growing medium without using a pot 62. In a preferred version, at least a portion of the sleeve 10-10p is constructed of a material resistant or impermeable to leakage, while the detachable upper portion, if present, is preferably constructed of a thinner transparent material.

Any of the floral sleeves described or contemplated herein, such as floral sleeves 10-10p may be secured about the pot 62 by a securing element as described above or by forming a crimped portion which is held in a crimped shape by an adhesive or cohesive bonding material. The securing element or crimped portion could be positioned either above or below the upper end 64 of the pot 62 when the pot 62 is disposed within the floral sleeve 10-10p.

It should be further noted that various features of the versions of the present invention such as closure bonding areas, support apertures, handles or handle apertures, additional perforations, drainage holes, ventilation holes, combinations of material may be used alone or in combination as elements of any of the embodiments described above herein.

Changes may be made in the construction and the operation of the various components, elements and assemblies described herein or in the steps or the sequence of steps of the methods described herein without departing from the spirit and scope of the invention as defined in the following claims.

1. A method of covering a pot, comprising the steps of:
providing a floral sleeve comprising a body having a flattened condition and having an upper end, a lower end, a first panel, a second panel, and an interior space, the first panel and the second panel together forming a sidewall in the body, the body tapered from the upper end to the lower end, and the floral sleeve further comprising a skirt insert attached to at least a portion of at least one of the first and second panels of the body of the sleeve; and
disposing a pot into at least a portion of the interior space of the body.

2. The method of claim 1 wherein, in the step of providing a floral sleeve, the skirt insert extends beyond the upper end of the body of the floral sleeve.

3. The method of claim 1 wherein, in the step of providing a floral sleeve, the upper end of the body of the sleeve is linear.

4. The method of claim 1 wherein, in the step of providing a floral sleeve, the upper end of the body of the sleeve is non-linear.

5. The method of claim 1 wherein, in the step of providing a floral sleeve, an upper end of the skirt insert is linear.

6. The method of claim 1 wherein, in the step of providing a floral sleeve, an upper end of the skirt insert is non-linear.

7. The method of claim 1 wherein, in the step of providing a floral sleeve, the floral sleeve further comprises a skirt portion having an upper edge.

8. The method of claim 1 wherein in the step of providing a floral sleeve, at least a portion of the skirt portion extends above an upper end of the pot after the pot is disposed into the interior space of the body.

9. The method of claim 8 wherein in the step of providing a floral sleeve, the upper edge of the skirt portion has a non-linear pattern.

10. The method of claim 1 wherein, in the step of providing the floral sleeve, the skirt insert is constructed of a material which is different from a material used to construct the body of the floral sleeve.

11. The method of claim 1 wherein, in the step of providing the floral sleeve, the skirt insert is constructed of a material having a decorative pattern or color disposed thereon.

12. The method of claim 11 wherein the body of the sleeve is constructed of a material having a decorative pattern or color disposed thereon, wherein the decorative pattern or color of the body of the sleeve is different from the decorative pattern or color of the skirt insert.

13. The method of claim 1 wherein, in the step of providing the floral sleeve, the body of the floral sleeve is constructed of a material selected from the group consisting of metallized film, polymer film, natural film, foil, spun bonded material, melt blown material, lace material, fabric, cellophane, cloth, paper, tissue, biodegradable material, recyclable material, metal foil, and combinations or laminations thereof.

14. The method of claim 1 wherein, in the step of providing the floral sleeve, the skirt insert of the floral sleeve is constructed of a material selected from the group consisting of metallized film, polymer film, natural film, foil, spun bonded material, melt blown material, lace material, fabric, cellophane, cloth, paper, tissue, biodegradable material, recyclable material, metal foil, and combinations or laminations thereof.

15. The method of claim 1 wherein, in the step of providing the floral sleeve, the floral sleeve further comprises an upper portion detachably connected to at least one of the body of the sleeve and the skirt insert of the sleeve.

16. The method of claim 1 comprising the additional step of securing the floral sleeve about the pot by disposing a securing element about the floral sleeve after the floral sleeve has been disposed about the pot.

17. The method of claim 16 wherein the securing element is selected from the group consisting of elastic bands, plastic bands, strings, labels, tapes, ribbons, ties, wires, stribbons, rubber bands, barbs, collars, staples and clips, and combinations thereof.

18. The method of claim 16 wherein the securing element is placed above an upper end of the pot.

19. The method of claim 16 wherein the securing element is placed below an upper end of the pot.

20. The method of claim 1 wherein in the step of providing a floral sleeve, the floral sleeve is provided by detaching the floral sleeve from a pad of the floral sleeves.

21. The method of claim 20 wherein the floral sleeves are connected in the pad via a connecting bonding material disposed between portions of adjacent floral sleeves in the pad.

22. The method of claim 20 wherein the floral sleeves are connected in the pad via a staple, clip, wicket, pin, tie, hanger, or wire.

23. A method of covering a pot, comprising the steps of:
providing a floral sleeve comprising a body having a flattened condition and having an upper end, a lower end, a first panel, a second panel, and an interior space, the first panel and the second panel together forming a sidewall in the body, the body tapered from the upper end to the lower end, and the floral sleeve further comprising a skirt extension attached to at least a portion of at least one of the first and second panels of the body of the sleeve; and
disposing a pot into at least a portion of the interior space of the body.

24. The method of claim 23 wherein, in the step of providing a floral sleeve, the skirt extension extends beyond the upper end of the body of the floral sleeve.

25. The method of claim 23 wherein, in the step of providing a floral sleeve, the upper end of the body of the sleeve is linear.

26. The method of claim 23 wherein, in the step of providing a floral sleeve, the upper end of the body of the sleeve is non-linear.

27. The method of claim 23 wherein, in the step of providing a floral sleeve, an upper end of the skirt extension is linear.

28. The method of claim 23 wherein, in the step of providing a floral sleeve, an upper end of the skirt extension is non-linear.

29. The method of claim 23 wherein, in the step of providing a floral sleeve, the floral sleeve further comprises a skirt portion having an upper edge.

30. The method of claim 23 wherein in the step of providing a floral sleeve, at least a portion of the skirt portion extends above an upper end of the pot after the pot is disposed into the interior space of the body.

31. The method of claim 30 wherein in the step of providing a floral sleeve, the upper edge of the skirt portion has a non-linear pattern.

32. The method of claim 23 wherein, in the step of providing the floral sleeve, the skirt extension is constructed of a material which is different from a material used to construct the body of the floral sleeve.

33. The method of claim 23 wherein, in the step of providing the floral sleeve, the skirt extension is constructed of a material having a decorative pattern or color disposed thereon.

34. The method of claim 33 wherein the body of the sleeve is constructed of a material having a decorative pattern or color disposed thereon, wherein the decorative pattern or color of the body of the sleeve is different from the decorative pattern or color of the skirt extension.

35. The method of claim 23 wherein, in the step of providing the floral sleeve, the body of the floral sleeve is constructed of a material selected from the group consisting of metallized film, polymer film, natural film, foil, spun bonded material, melt blown material, lace material, fabric, cellophane, cloth, paper, tissue, biodegradable material, recyclable material, metal foil, and combinations or laminations thereof.

36. The method of claim 23 wherein, in the step of providing the floral sleeve, the skirt extension of the floral sleeve is constructed of a material selected from the group consisting of metallized film, polymer film, natural film, foil, spun bonded material, melt blown material, lace material, fabric, cellophane, cloth, paper, tissue, biodegradable material, recyclable material, metal foil, and combinations or laminations thereof.

37. The method of claim 23 wherein, in the step of providing the floral sleeve, the floral sleeve further comprises an upper portion detachably connected to at least one of the body of the sleeve and the skirt extension of the sleeve.

38. The method of claim 23 comprising the additional step of securing the floral sleeve about the pot by disposing a securing element about the floral sleeve after the floral sleeve has been disposed about the pot.

39. The method of claim 38 wherein the securing element is selected from the group consisting of elastic bands, plastic bands, strings, labels, tapes, ribbons, ties, wires, stribbons, rubber bands, barbs, collars, staples and clips, and combinations thereof.

40. The method of claim 38 wherein the securing element is placed above an upper end of the pot.

41. The method of claim 38 wherein the securing element is placed below an upper end of the pot.

42. The method of claim 23 wherein in the step of providing a floral sleeve, the floral sleeve is provided by detaching the floral sleeve from a pad of the floral sleeves.

43. The method of claim 42 wherein the floral sleeves are connected in the pad via a connecting bonding material disposed between portions of adjacent floral sleeves in the pad.

44. The method of claim 42 wherein the floral sleeves are connected in the pad via a staple, clip, wicket, pin, tie, hanger, or wire.

45. A method of covering a floral grouping, comprising the steps of:
providing a floral sleeve comprising a body having a flattened condition and having an upper end, a lower end, a first panel, a second panel, and an interior space, the first panel and the second panel together forming a sidewall in the body, the body tapered from the upper end to the lower end, and the floral sleeve further comprising a skirt insert attached to at least a portion of at least one of the first and second panels of the body of the sleeve; and
disposing a floral grouping into at least a portion of the interior space of the body.

46. The method of claim 45 wherein, in the step of providing a floral sleeve, the skirt insert extends beyond the upper end of the body of the floral sleeve.

47. The method of claim 45 wherein, in the step of providing a floral sleeve, the upper end of the body of the sleeve is linear.

48. The method of claim 45 wherein, in the step of providing a floral sleeve, the upper end of the body of the sleeve is non-linear.

49. The method of claim 45 wherein, in the step of providing a floral sleeve, an upper end of the skirt insert is linear.

50. The method of claim 45 wherein, in the step of providing a floral sleeve, an upper end of the skirt insert is non-linear.

51. The method of claim 45 wherein, in the step of providing a floral sleeve, the floral sleeve further comprises a skirt portion having an upper edge.

52. The method of claim 51 wherein in the step of providing a floral sleeve, the upper edge of the skirt portion has a non-linear pattern.

53. The method of claim 45 wherein, in the step of providing the floral sleeve, the skirt insert is constructed of a material which is different from a material used to construct the body of the floral sleeve.

54. The method of claim 45 wherein, in the step of providing the floral sleeve, the skirt insert is constructed of a material having a decorative pattern or color disposed thereon.

55. The method of claim 54 wherein the body of the sleeve is constructed of a material having a decorative pattern or color disposed thereon, wherein the decorative pattern or color of the body of the sleeve is different from the decorative pattern or color of the skirt insert.

56. The method of claim 45 wherein, in the step of providing the floral sleeve, the body of the floral sleeve is constructed of a material selected from the group consisting of metallized film, polymer film, natural film, foil, spun bonded material, melt blown material, lace material, fabric, cellophane, cloth, paper, tissue, biodegradable material, recyclable material, metal foil, and combinations or laminations thereof.

57. The method of claim 45 wherein, in the step of providing the floral sleeve, the skirt insert of the floral sleeve is constructed of a material selected from the group consisting of metallized film, polymer film, natural film, foil, spun bonded material, melt blown material, lace material, fabric, cellophane, cloth, paper, tissue, biodegradable material, recyclable material, metal foil, and combinations or laminations thereof.

58. The method of claim 45 wherein, in the step of providing the floral sleeve, the floral sleeve further comprises an upper portion detachably connected to at least one of the body of the sleeve and the skirt insert of the sleeve.

59. The method of claim 45 comprising the additional step of securing the floral sleeve about the floral grouping by disposing a securing element about the floral sleeve after the floral sleeve has been disposed about the floral grouping.

60. The method of claim 59 wherein the securing element is selected from the group consisting of elastic bands, plastic bands, strings, labels, tapes, ribbons, ties, wires, stribbons, rubber bands, barbs, collars, staples and clips, and combinations thereof.

61. The method of claim 59 wherein the securing element is placed about a portion of a stem portion of the floral grouping.

62. The method of claim 59 wherein in the step of providing a floral sleeve, the floral sleeve is provided by detaching the floral sleeve from a pad of the floral sleeves.

63. The method of claim 62 wherein the floral sleeves are connected in the pad via a connecting bonding material disposed between portions of adjacent floral sleeves in the pad.

64. The method of claim 62 wherein the floral sleeves are connected in the pad via a staple, clip, wicket, pin, tie, hanger, or wire.

65. A method of covering a floral grouping, comprising the steps of:
providing a floral sleeve comprising a body having a flattened condition and having an upper end, a lower end, a first panel, a second panel, and an interior space, the first panel and the second panel together forming a sidewall in the body, the body tapered from the upper end to the lower end, and the floral sleeve further comprising a skirt extension attached to at least a portion of at least one of the first and second panels of the body of the sleeve; and
disposing a floral grouping into at least a portion of the interior space of the body.

66. The method of claim 65 wherein, in the step of providing a floral sleeve, the skirt extension extends beyond the upper end of the body of the floral sleeve.

67. The method of claim 65 wherein, in the step of providing a floral sleeve, the upper end of the body of the sleeve is linear.

68. The method of claim 65 wherein, in the step of providing a floral sleeve, the upper end of the body of the sleeve is non-linear.

69. The method of claim 65 wherein, in the step of providing a floral sleeve, an upper end of the skirt extension is linear.

70. The method of claim 65 wherein, in the step of providing a floral sleeve, an upper end of the skirt extension is non-linear.

71. The method of claim 65 wherein, in the step of providing a floral sleeve, the floral sleeve further comprises a skirt portion having an upper edge.

72. The method of claim 71 wherein in the step of providing a floral sleeve, the upper edge of the skirt portion has a non-linear pattern.

73. The method of claim 65 wherein, in the step of providing the floral sleeve, the skirt extension is constructed of a material which is different from a material used to construct the body of the floral sleeve.

74. The method of claim 65 wherein, in the step of providing the floral sleeve, the skirt extension is constructed of a material having a decorative pattern or color disposed thereon.

75. The method of claim 74 wherein the body of the sleeve is constructed of a material having a decorative pattern or color disposed thereon, wherein the decorative pattern or color of the body of the sleeve is different from the decorative pattern or color of the skirt extension.

76. The method of claim 65 wherein, in the step of providing the floral sleeve, the body of the floral sleeve is constructed of a material selected from the group consisting of metallized film, polymer film, natural film, foil, spun bonded material, melt blown material, lace material, fabric, cellophane, cloth, paper, tissue, biodegradable material, recyclable material, metal foil, and combinations or laminations thereof.

77. The method of claim 65 wherein, in the step of providing the floral sleeve, the skirt extension of the floral sleeve is constructed of a material selected from the group consisting of metallized film, polymer film, natural film, foil, spun bonded material, melt blown material, lace material, fabric, cellophane, cloth, paper, tissue, biodegradable material, recyclable material, metal foil, and combinations or laminations thereof.

78. The method of claim 65 wherein, in the step of providing the floral sleeve, the floral sleeve further comprises an upper portion detachably connected to at least one of the body of the sleeve and the skirt extension of the sleeve.

79. The method of claim 65 comprising the additional step of securing the floral sleeve about the floral grouping by disposing a securing element about the floral sleeve after the floral sleeve has been disposed about the floral grouping.

80. The method of claim 79 wherein the securing element is selected from the group consisting of elastic bands, plastic bands, strings, labels, tapes, ribbons, ties, wires, stribbons, rubber bands, barbs, collars, staples and clips, and combinations thereof.

81. The method of claim 79 wherein the securing element is placed about a portion of a stem portion of the floral grouping.

82. The method of claim 65 wherein in the step of providing a floral sleeve, the floral sleeve is provided by detaching the floral sleeve from a pad of the floral sleeves.

83. The method of claim 82 wherein the floral sleeves are connected in the pad via a connecting bonding material disposed between portions of adjacent floral sleeves in the pad.

84. The method of claim 82 wherein the floral sleeves are connected in the pad via a staple, clip, wicket, pin, tie, hanger, or wire.
